(19) United States
(12) Patent Application Publication
(10) Pub. No.: US 2009/0299772 A1
(43) Pub. Date: Dec. 3, 2009

(54) Pet passenger insurance coverage and methods therefor

(76) Inventor: Alexander I. Arezina, Elmhurst, IL (US)

Correspondence Address: Alexander I. Arezina, 301 Geneva Ave, Elmhurst, IL, 60126, US

(21) Appl. No.: 12/156,067

(22) Filed: May 29, 2008

(51) Int. Cl. G06Q 40/00

(52) U.S. Cl. 705/4

(57) ABSTRACT

A method of insuring pet passengers of motor vehicles comprises collecting underwriting data from a prospective customer, the underwriting data including identification of at least one covered pet, and issuing an insurance policy to the prospective customer, the prospective customer becoming an insured under the insurance policy, the insured owning the at least one covered pet. The method further comprises determining the occurrence of a covered loss, the covered loss comprising one of injury to, death of or disappearance of the at least one covered pet caused by a motor vehicle collision and paying a first payment for the purposes of paying covered expenses related to the covered loss.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to insurance products and methods for providing insurance, and more particularly, to pet passenger insurance coverage and methods for providing the same.

### BACKGROUND OF THE INVENTION

Personal insurance products have been a cornerstone of the insurance industry for many years. Generally, such products have included automobile insurance, homeowner's insurance, renter's insurance, and umbrella liability policies. In addition to personal insurance products, commercial insurance products continue to grow in sales each year and include such products as commercial automobile insurance and garage liability insurance. Because insurance products and services are heavily regulated by various states, localities, and other jurisdictions, coverage offerings from various insurers tend to be similar due to industry standardization, and thus pricing for such insurance products is often very competitive. Thus, clever insurance companies have turned to offering additional or ancillary products or services to distinguish themselves in the market place and entice customers to purchase insurance.

Generally, the appeal of certain insurance products to potential purchasers is dependent upon price and perceived value. Such perceived value may include quality of service, ease of claims processing, availability of resources and other factors. Price, however, is frequently based upon the same or similar underwriting factors, such that prices amongst various insurance companies are often quite competitive. Thus, ancillary products or services may influence potential purchasers of insurance to choose a particular insurance company as their provider.

The present invention relates to a new category of insurance products which may be offered by insurance companies to current and prospective customers. Disclosed and described herein is the product of pet passenger insurance coverage which can be offered in the form of supplemental coverage, endorsements, or standalone insurance policies.

### SUMMARY OF THE INVENTION

According to one aspect of the present invention, a method of insuring pet passengers of motor vehicles comprises collecting underwriting data from a prospective customer, the underwriting data including identification of at least one covered pet, and issuing an insurance policy to the prospective customer, the prospective customer becoming an insured under the insurance policy, the insured owning the at least one covered pet. The method further comprises determining the occurrence of a covered loss, the covered loss comprising one of injury to, death of or disappearance of the at least one covered pet caused by a motor vehicle collision and paying a first payment for the purposes of paying covered expenses related to the covered loss.

According to another aspect of the invention, a method of offering pet passenger coverage comprises receiving a request for motor vehicle insurance from a prospective customer, collecting underwriting data from the prospective customer, and offering to the prospective customer supplemental insurance coverage comprising pet passenger coverage for at least one covered pet, wherein the pet passenger coverage compensates for covered expenses related to injury to, death of or disappearance of the at least one covered pet in a motor vehicle collision. The method further comprises receiving from the prospective customer acceptance of the offer of supplemental insurance coverage, and issuing both a motor vehicle insurance policy and the supplemental insurance coverage to the prospective customer wherein the prospective customer becomes an insured under the motor vehicle insurance policy.

According to yet another aspect of the invention, a method of paying expenses pursuant to an insurance policy comprises receiving a claim for payment from an insured and determining that the insured is covered under at least one insurance policy including pet passenger motor vehicle coverage covering at least one covered pet. The method further comprises determining a covered loss under the at least one insurance policy has occurred, the covered loss comprising the at least one covered pet being injured, killed or disappearing in a motor vehicle collision and paying covered expenses related to the treatment, disposal or replacement of the at least one covered pet to either (i) the insured or (ii) on the insured's behalf.

According to yet another aspect of the invention, one or more computer readable storage media is encoded with instructions for directing a computer to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a flowchart of a method of insuring pet passengers of motor vehicles.

FIG. 2 is a flowchart of a method of offering pet passenger coverage.

FIG. 3 is a flowchart of a method of paying expenses pursuant to an insurance policy.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

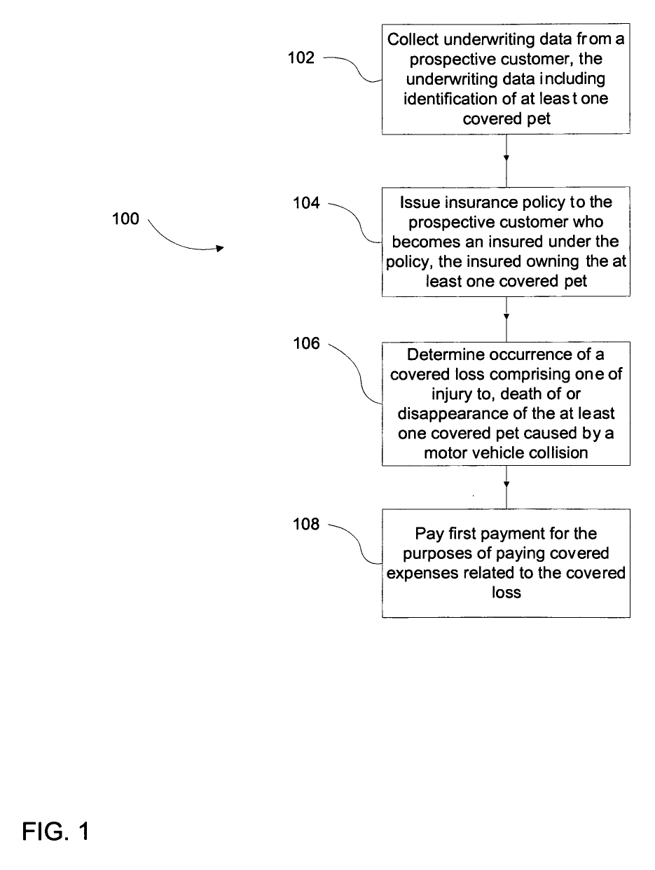

Referring to FIG. 1, a flowchart of a method 100 of insuring pet passengers of motor vehicles is depicted. At step 102, underwriting data is collected from a prospective customer. The underwriting data includes identification of at least one covered pet. At step 104, an insurance policy is issued to the prospective customer wherein the prospective customer becomes an insured under the insurance policy. In one embodiment, the named insured owns the at least one covered pet. At step 106, the occurrence of a covered loss is detected and determined, wherein the covered loss comprises one of injury to, death of or disappearance of the at least one covered pet caused by a motor vehicle collision. At step 108, a first payment is paid for the purposes of paying covered expenses related to the covered loss.

In the method 100, the underwriting data may include personal data such as name, address, telephone number, social security number, driver's license number, and other identifying information. Other underwriting data may include marital status, credit score, age, driving record, vehicle information, educational background, employment information, claims history, home ownership, etc. The underwriting data may also include information related to the at least one covered pet. Such underwriting data may include the number of pets to be insured, and for each pet, the type or species of pet, the age of the pet, the weight, the color of the pet, the pedigree documentation of the pet, the purchase/acquisition documentation of the pet, the medical/veterinary history of the pet, etc. The underwriting data may be collected directly from the prospective customer, or may be compiled from secondary sources using other information, such as the personal data collected. For example, a person's social security number or driver's license number may be used to cross-reference databases such as those maintained by a state or locality's motor vehicle division or secretary of state.

Moreover, the insurance policy is issued to the prospective customer who becomes an insured. However, the policy may include other people as insureds under the policy. For example, the prospective customer's spouse, children, parents, or other family or household members may become insureds under the policy as well. Moreover, certain eligibility criteria may be placed on such additional individuals in order that they may qualify as insureds under the policy. In one embodiment, the prospective customer's family members become insureds under the policy only if they reside with the prospective customer. In other embodiments, it may be required that the at least one covered pet resides or is kept in the insured's residence. Many other varieties of eligibility criteria may be employed as well in determining whether or not certain individuals are insureds under the policy. Moreover, in step 102, the collected underwriting data may pertain to those other than the prospective customer who may become insured under the policy.

A covered loss may be detected or determined using a number of methods. For example, an insured under the policy may file or initiate a claim with the insurance company issuing the policy. The claim may be initiated in writing, in person, telephonically, or electronically (using email or over the internet, for example, using a website interface provided by the insurance company or its agent or representative). The filing of the claim may require the insured to submit certain information and/or evidence to assist the insurance company in determining whether or not the claim is covered by the insurance policy. In one embodiment, the insured may be required to submit both information related to the triggering motor vehicle collision as well as information related to the pet being injured or killed. For example, a police accident report may be required as evidence of the collision. Veterinary bills and related treatment records may be required to prove the veterinary charges incurred and that they stem from injuries sustained by the pet in the subject motor vehicle collision. The insurer, in turn, may use this information to determine whether the collision and charges submitted are covered under the policy language.

Because the policy is designed to provide coverage in the event that an insured's pet is injured, killed or disappears in a motor vehicle collision, the coverage determination requires that proof of the collision be provided. For example, the insured may have to submit evidence of the collision in the form of a police report, or in the alternative, by submitting photographs, videos, or perhaps a copy of a traffic citation, ticket, summons, or other charging papers issued to a party to the collision. The insured may also be required to submit evidence that the death, injury or disappearance of the pet was due to the motor vehicle collision, for example, by submitting an opinion of a licensed veterinarian explaining the pets injuries and causal relationship thereto. The coverage determination further requires that charges submitted for payment are covered under the pet passenger coverage. Thus, a comparison must be made between the expenses and costs submitted and those covered categories of charges enumerated, listed, or otherwise covered by the policy. Finally, the coverage determination may also depend on (and therefore require) investigation of other ancillary matters. For example, the insurance company may need to verify that the collision occurred during the active policy period, that the policy premium was fully and timely paid, that the insurance policy limits have not been exhausted, and that other exclusions under the policy do not apply. In various embodiments, the coverage under the policy may or may not be dependent upon negligence or fault in causing the underlying motor vehicle collision. Thus, in one embodiment, the coverage is comprehensive in nature, and is available to the insured regardless of who is at fault in causing the triggering motor vehicle collision. In another embodiment, the coverage may be triggered only if insured was not at fault in causing the collision. Provided that these matters are all resolved favorably, the determination of a covered loss may be made.

Payment of the first payment may comprise a variety of payments which together are referred to as “the first payment.” For example, in one embodiment, the first payment is paid directly to the insured. In another embodiment, the first payment may be made to one or more third parties to whom related expenses are due and owing. For example, if the policy includes veterinary charges, medical coverage, pet funeral and/or disposal costs, pet replacement costs, etc., those expenses may be paid as part of the first payment by issuing payment to the appropriate service provider (veterinarian, for example). In another embodiment, the first payment may comprises payment for replacement of the at least one pet, for example, if the pet is deceased or disappears. The first payment may be a predetermined amount, such as a fixed payout amount or policy limit which is paid to the insured in response to a covered loss. Alternatively, the first payment may be a variable amount which depends on the amount of covered incurred expenses which are submitted by the insured in a claim. The policy or coverage may include a policy or coverage limit as well, such that the first payment amount may be the lesser of the policy/coverage limit or the submitted covered expenses. As used herein “coverage” and “policy” are used interchangeably, regardless of whether the pet passenger insurance coverage is provided as a standalone policy, or as an optional coverage or endorsement to some other insurance policy or coverage.

Additionally, many variations or additions to the steps of the method are possible in various embodiments. In one embodiment, the first payment is a predetermined amount which is based upon a policy premium collected from the insured. Thus, in such an embodiment, the more coverage an insured desires, the greater policy premium he or she must pay. Moreover, in such an embodiment, the fixed predetermined amount is paid out as the first payment regardless of the actual costs for pet treatment which are incurred. The insured would need to demonstrate in such an embodiment that a covered loss has occurred in the form of the covered pet being injured, killed, or disappearing relative to a motor vehicle collision. Once a covered loss is determined, as described herein, the first payment is issued in an amount indicated in the insurance policy.

In alternative embodiments, the method 100 may further comprise additional steps. For example, an optional step may comprise receiving a policy premium payment from the insured. The policy premium may be paid in a variety of ways. For example, the premium may be paid in one lump-sum payment at or near the time of issuance of the policy. Alternatively, the premium may be paid periodically, such as monthly, weekly or quarterly. One or more convenience fees may be charged to the insured based upon the payment plan selected by the insured in an effort to offset the additional costs of providing such alternative payment plans. In another alternative embodiment, once the entire amount of a policy limit of the insurance policy is paid, the method 100 may include an optional step of declaring the policy limits exhausted. The policy premiums may be paid to the insurer directly by the insured (“direct bill”) or alternatively may be paid to the insurer by an insurance agent who collects the policy premium from the insured (“agency bill”).

As used herein, “medical” or “veterinary” charges refer to any charges associated with the treatment rendered to an injured pet. For example, such charges may include a veterinarian's fees, animal hospital charges, or other physician's charges. Moreover, such fees may include associated charges such as burial and/or disposal fees or charges in the event of death of the pet. Additionally, such charges may include transportation charges and ancillary charges associated with the medical treatment rendered.

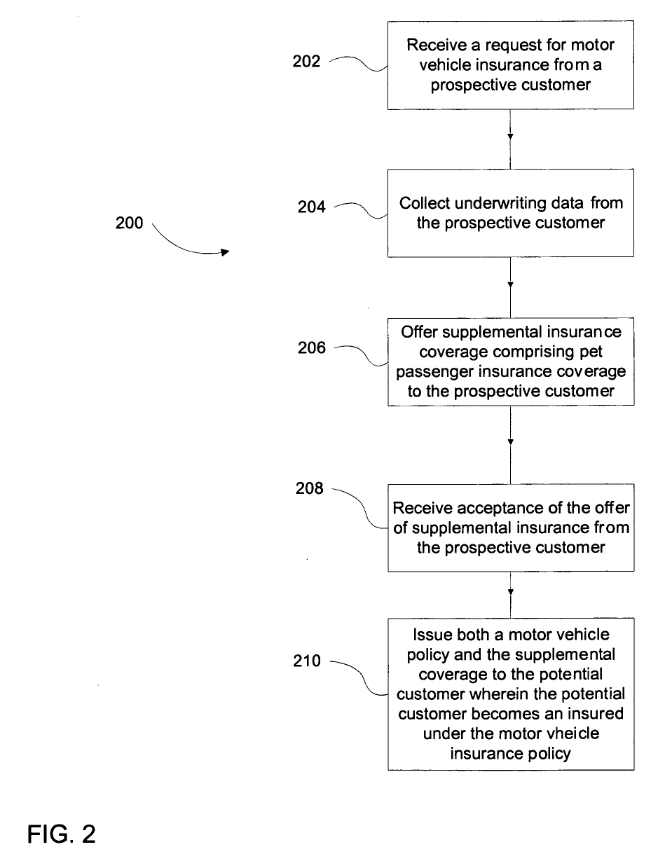

Referring to FIG. 2, a flowchart of a method 200 of offering pet passenger coverage is depicted. At step 202, a request for motor vehicle insurance in received from a prospective customer. At step 204, underwriting data is collected from the prospective customer. At step 206, supplemental insurance coverage is offered to the prospective customer. The supplemental insurance coverage comprises pet passenger coverage for at least one covered pet, wherein the pet passenger coverage compensates for covered expenses related to injury to or death of the at least one covered pet in a motor vehicle collision. At step 208, acceptance of the offer of supplemental insurance coverage is received from the prospective customer. At step 210, both a motor vehicle insurance policy and the supplemental coverage are issued to the prospective customer wherein the prospective customer becomes an insured under the motor vehicle insurance policy.

The method begins with a request from a prospective customer for automobile insurance being received. Customers may be shopping for automobile liability coverage, physical damage coverage, and other associated coverages such as medical payments, uninsured and underinsured coverage, etc. Thus, the method, as described herein offers the invention of pet passenger coverage as a supplemental insurance coverage in conjunction with a request for traditional motor vehicle coverage such as automobile insurance.

The request from the prospective customer may be received in a variety of manners. For example, the request may be received in person, telephonically, in writing, or electronically (e.g. email, internet, etc.). In one embodiment, the prospective customer may initiate a request electronically via email or a website provided and operated by or on behalf of the insurance company issuing the pet passenger insurance coverage or policy. For example, insurance companies offering such coverage may operate interactive websites accessible on the internet which prospective customers may use to initiate such a request. Similarly, underwriting data may be collected from the prospective customer in one or more of the same manners. In the internet example, the website may prompt a user to input certain underwriting data, including personal data and traffic history data as described previously herein. Moreover, the request may be delivered via an intermediary such as an insurance agent, as described elsewhere herein.

Similarly, the step of offering supplemental insurance in the form of pet passenger coverage may be accomplished in a number of ways. Such insurance may be offered in writing, in person, telephonically or electronically. In the internet example described above, upon completion of the underwriting process, a decision may be made to either insure the potential customer or not. If coverage is to be offered to the potential customer, it may offered via the internet site and inform the potential customer of the details of the offer. Alternatively, the offer may be made by email to the customer. The manner in which the offer is made may be the same as or different from the manners in which the request is received from the customer and the underwriting data is collected.

Both a motor vehicle policy (such as an automobile policy) and the supplemental pet passenger coverage are issued to the prospective customer. The pet passenger coverage may be embodied in one or more endorsements to the automobile insurance policy. Alternatively, the pet passenger coverage may be provided as one or more optional coverages contained in the automobile insurance policy. In yet another embodiment, the pet passenger coverage may be provided in a separate or standalone policy. In one embodiment, the prospective customer becomes an insured under the automobile policy. In other embodiments, the prospective customer may also become an insured under one or more additional policies, for example a standalone policy containing the pet passenger coverage.

It should be understood that any of the transactions between the insurance company issuing such pet passenger coverage and an insured or prospective customer may occur either directly, or via an intermediary. In one embodiment, the intermediary may be an insurance agent. The insurance agent may be an independent agent or may be an internal agent, such as an employee or captive of the insurer. In transacting business through the agent, any steps of the methods described herein may be conducted through the intermediary. For example, the request for motor vehicle insurance in step 202 may be made by the prospective customer to an intermediary, such as an insurance agent, who in turn relays the request to an appropriate insurance company. Likewise, issuance of the policy from the insurance company to the insured may be made via the insurance agent intermediary. Many other interactions between the insured and the insurance company (e.g. claims, payment, amendments in coverage, etc.) may be accomplished via the agent or other intermediary.

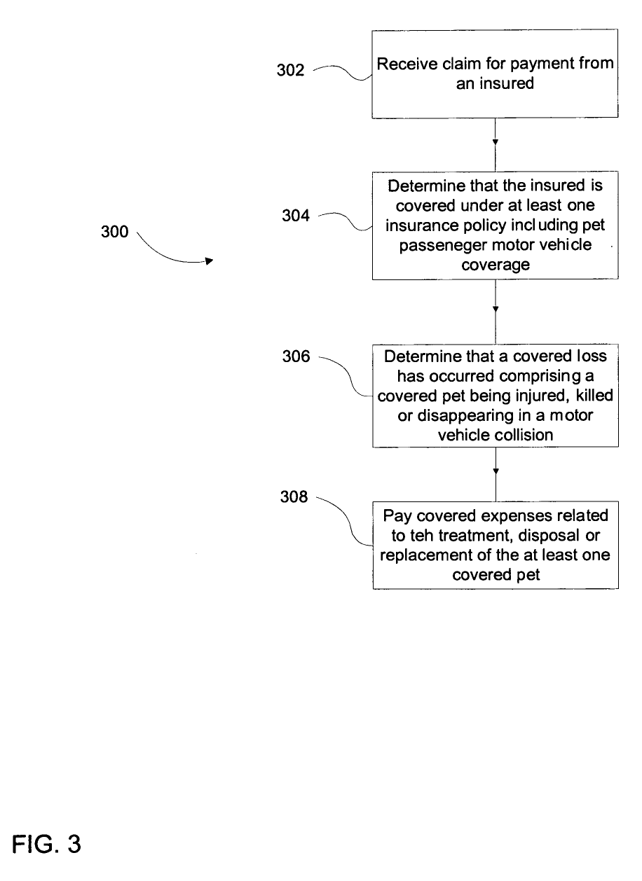

Referring to FIG. 3, a flowchart of a method 300 of paying veterinary medicine expenses pursuant to an insurance policy is depicted. At step 302, a claim for payment from an insured is received. At step 304, it is determined that the insured is covered under at least one insurance policy including pet passenger motor vehicle coverage covering at least one covered pet. At step 306, it is determined that a covered loss under the at least one insurance policy has occurred. The covered loss comprises the at least one covered pet being injured, killed or disappearing in a motor vehicle collision. At step 308, covered expenses related to the treatment, disposal or replacement of the at least one covered pet are paid to either (i) the insured or (ii) on the insured's behalf.

As before, the claim for payment may be received by an insurance company from an insured in a variety of manners. For example, the claim may be received in writing, in person, telephonically, or electronically. Also, the claim may be received directly from the insured, or alternatively may be received via an intermediary such as insurance agent. The determination that the insured is covered under a policy including pet passenger expense coverage may involve a number of steps, including but not limited to those previously enumerated herein. For example, such a determination may include verification that the injuries to or death of the covered pet occurred during an active policy period, that the insured is an insured under the policy, that all premiums have been paid, that the policy limits have not been exhausted and that no other exclusions apply.

Payment of the covered expenses may be made in a number of manners as well. Payment may be made directly to the insured, or to third parties on the insured's behalf, or both. Moreover, the payment of covered expenses may be a fixed amount (for example a policy limit amount), or may be a variable amount which varies based upon the total of expenses incurred or claimed. As before, the covered expenses may comprise a variety of expenses incurred as a consequence of the injury to or death of a covered pet from injuries sustained in a covered motor vehicle collision.

In some alternative embodiments, a variety of exclusions may be defined within such pet passenger insurance policies. Some example exclusions which may be defined therein are (i) whether the pet is an owned pet, (ii) whether the driver was an insured under the policy, (iii) whether the insured was driving an owned vehicle, (iv) whether the insured was driving a covered vehicle, (v) whether the loss occurred during the policy period, (vi) not a covered type or species of pet, (vii) not a domestic animal, (viii) veterinary, medical, or disposal services provided by unlicensed individuals or entities, (ix) failure to provide a veterinary opinion as to cause of loss, etc. Moreover, in some embodiments one or more deductibles may be imposed on the pet passenger coverage such that one or more payments for covered losses under the policy are subject to (and thus reduced by) the deductible.

In some embodiments of the present invention, one or more policy or coverage premiums may be charged for the provided pet passenger insurance coverage. In other words, the customer may be charged a separate policy or coverage amount relating to the pet passenger insurance coverage. However, in other embodiments, the “cost” of the pet passenger related insurance coverage may be lumped in with other coverages (e.g. personal automobile coverage) such that the customer is not charged a separately defined or stated amount. The cost of the pet passenger insurance is reflected in an increased policy premium for the other provided coverages (e.g. personal automobile coverage). In yet other embodiments, the pet passenger insurance coverage may be provided to a customer at no additional charge so as to differentiate the insurer's products and gain market share through customer popularity and desirability of the additional coverage included as “standard.”

One or more steps of the above methods may be conducted on or performed with the assistance of computers, processors, and other digital equipment. Thus, one or more computer readable storage media may be encoded with instructions for performing the above described methods, and the steps therein. For example, a computer may be programmed to receive insurance requests, prompt and collect data, issue a pet passenger insurance policy (or coverage), etc. Moreover, computer readable storage media may also be programmed with instructions for claims processing of such pet passenger insurance policies, including receiving, analyzing and processing claim data and issuing payments attendant thereto. Thus, the methods may be performed manually, digitally with the assistance of a computing device, or both.

Although many of the examples used herein are related to personal lines insurance products, pet passenger insurance coverage may be offered in conjunction with numerous types of commercial insurance products as well. For example, commercial automobile policies, commercial property coverage, general liability policies, and/or garage liability policies may be co-marketed, sold with or otherwise associated with the described pet passenger coverage. Moreover, underwriting data and claims data collected in association with such pet passenger coverage may be used to adjust premiums on such commercial policies as well, as described herein with reference to personal lines products.

In one alternative embodiment of the invention, a motor vehicle collision may be defined to include any object impacting or coming in contact with an insured vehicle. In such an embodiment, even losses which are traditionally considered “comprehensive” losses may be covered. For example, a tree branch falling on a parked vehicle and injuring or killing a covered pet therein may be a covered loss. Thus, as used herein, “motor vehicle collision” means any object striking, impacting, or coming in contact with an insured vehicle. Moreover, even losses such as theft, vandalism, or fire to the insured vehicle which cause injury, death, or disappearance of a pet located in the vehicle may be covered in some embodiments, and thus constitute a covered loss.

It should be understood that although the steps of the methods 100, 200, 300, 400, 500 are depicted herein in the FIGURES having a particular order, such depictions are merely examples of the order of the steps of the methods. Such depictions are not intended to be the only order in which the steps of the methods 100, 200, 300, 400, 500 may be performed and are not limiting in any way.

Each of these embodiments and obvious variations thereof is contemplated as falling within the spirit and scope of the claimed invention, which is set forth in the following claims.

What is claimed is:

1. A method of insuring pet passengers of motor vehicles comprising:
collecting underwriting data from a prospective customer, the underwriting data including identification of at least one covered pet;
issuing an insurance policy to the prospective customer, the prospective customer becoming an insured under the insurance policy, the insured owning the at least one covered pet;
determining the occurrence of a covered loss, the covered loss comprising one of injury to, death of or disappearance of the at least one covered pet caused by a motor vehicle collision; and
paying a first payment for the purposes of paying covered expenses related to the covered loss.

2. The method of claim 1, wherein the first payment is a predetermined amount paid to the insured.

3. The method of claim 2, wherein the predetermined amount is based upon a policy premium.

4. The method of claim 1, wherein the covered expenses include medical or veterinary bills.

5. The method of claim 1, further comprising receiving a policy premium from the insured.

6. The method of claim 1, wherein the first payment comprises an amount equal to a lesser of a policy limit or a total of covered expenses related to the covered loss.

7. The method of claim 1, further comprising declaring a policy limit of the insurance policy exhausted following payment of the first payment.

8. The method of claim 1, wherein the at least one covered pet is a dog or a cat.

9. The method of claim 1, wherein the step of determining the occurrence of a covered loss comprises determining that (i) a covered motor vehicle collision occurred, (ii) the collision occurred during an effective term of the insurance policy, (iii) the at least one covered pet was injured, killed or disappeared as a result of the motor vehicle collision, and (iv) the insured incurred charges related to the injury, death or disappearance of the at least one covered pet.

10. A method of offering pet passenger coverage comprising:
receiving a request for motor vehicle insurance from a prospective customer;
collecting underwriting data from the prospective customer;
offering to the prospective customer supplemental insurance coverage comprising pet passenger coverage for at least one covered pet, wherein the pet passenger coverage compensates for covered expenses related to injury to, death of or disappearance of the at least one covered pet in a motor vehicle collision;
receiving from the prospective customer acceptance of the offer of supplemental insurance coverage; and
issuing both a motor vehicle insurance policy and the supplemental insurance coverage to the prospective customer wherein the prospective customer becomes an insured under the motor vehicle insurance policy.

11. The method of claim 10, wherein the covered expenses include medical or veterinary charges for injury to the at least one covered pet.

12. The method of claim 10, wherein the supplemental insurance coverage is provided by either (i) one or more endorsements to the motor vehicle insurance policy or (ii) one or more optional coverages contained in the motor vehicle insurance policy.

13. The method of claim 10, wherein the supplemental insurance coverage is provided as a standalone policy.

14. The method of claim 10, wherein the request is received from the prospective customer via an intermediary.

15. The method of claim 14, wherein the intermediary is an insurance agent.

16. The method of claim 10, wherein the at least one covered pet is a dog or a cat.

17. A method of paying expenses pursuant to an insurance policy comprising:
receiving a claim for payment from an insured;
determining that the insured is covered under at least one insurance policy including pet passenger motor vehicle coverage covering at least one covered pet;
determining a covered loss under the at least one insurance policy has occurred, the covered loss comprising the at least one covered pet being injured, killed or disappearing in a motor vehicle collision; and
paying covered expenses related to the treatment, disposal or replacement of the at least one covered pet to either (i) the insured or (ii) on the insured's behalf.

18. The method of claim 17, wherein the covered expenses include veterinary charges.

19. The method of claim 17, wherein the covered expenses include charges for euthanizing or replacing the at least one covered pet.

20. The method of claim 17, wherein the at least one covered pet is a dog or a cat.
